(19) United States
(12) Patent Application Publication
(10) Pub. No.: US 2020/0189015 A1
(43) Pub. Date: Jun. 18, 2020

(54) GEAR CUTTING TOOL, GEAR MACHINING APPARATUS, AND GEAR MACHINING METHOD

(71) Applicant: JTEKT Corporation, Osaka-shi (JP)

(72) Inventors: Takuya NAKAYAMA, Nagoya-shi (JP); Minoru SATO, Okazaki-shi (JP)

(73) Assignee: JTEKT Corporation, Osaka-shi (JP)

(21) Appl. No.: 16/710,000

(22) Filed: Dec. 11, 2019

(30) Foreign Application Priority Data
Dec. 13, 2018 (JP) 2018-233538

(51) Int. Cl. B23F 5/20

(52) U.S. Cl. CPC B23F 5/202

(57) ABSTRACT

A gear cutting tool configured to machine a workpiece with a skiving so as to generate a gear tooth includes a ring-shaped tool main body, and a plurality of tool blades which are replaceable and attached to the tool main body, such that the tool blades are arranged in a circumferential direction of the tool main body and a blade tip of each of the tool blades is oriented inward in a radial direction of the tool main body. Since the gear cutting tool for skiving is an internal gear type tool, the accuracy and the tool life of external gear machining when using the internal gear type tool are higher and longer than the accuracy and the tool life of external gear machining when using an external gear type tool. As a result, the frequency of replacement of the tool blades can be lowered and cost can be reduced.

### CROSS-REFERENCE TO RELATED APPLICATIONS

This application is based on and claims priority under 35 USC 119 from Japanese Patent Application No. 2018-233538 filed on Dec. 13, 2018, the contents of which are incorporated herein by reference.

### TECHNICAL FIELD

The present disclosure relates to a gear cutting tool, a gear machining apparatus, and a gear machining method.

### BACKGROUND ART

In recent years, gear machining capable of high-speed working has come to be desired from the viewpoint of cost reduction. Skiving as described in JP2012-171020A is one example. In skiving, a gear cutting tool and a workpiece are set in such a manner that their axial lines cross each other (i.e., they have a crossing angle which is a term used in gear machining). The gear cutting tool is moved relative to the workpiece parallel with the axial line of the workpiece while they are rotated synchronously about their respective axial lines.

External gear type gear cutting tools (hereinafter referred to as “external gear type tools”) capable of producing an external gear and an internal gear are commonly used as gear cutting tools for skiving. However, external gear type gear cutting tools are, in general, made of a solid high speed tool steel and hence are very expensive. In view of this, JP2015-44282A and JP2016-16514A disclose external gear type tools in which replacement of only tool blades is possible. In this case, only replacement of tool blades, rather than replacement of a tool, determines cost, resulting in cost reduction.

In external gear type tools, in general, the meshing length of external gear machining is shorter than that of internal gear machining. Thus, in external gear type tools, their tool blades wear more in external gear machining than in internal gear machining. As a result, in external gear type tools, the accuracy of external gear machining and the life of the external gear type tool used are lower or shorter than the accuracy of internal gear machining and the life of the external gear type tool used. This leads to increase of the frequency of replacement of tool blades and cost increase.

The present disclosure provides a low-cost gear cutting tool for skiving and a gear machining apparatus and a gear machining method that employ this gear cutting tool.

### SUMMARY OF INVENTION

According to an aspect of the present disclosure, a gear cutting tool configured to machine a workpiece with a skiving so as to generate a gear tooth includes a ring-shaped tool main body, and a plurality of tool blades which are replaceable and attached to the tool main body, such that the tool blades are arranged in a circumferential direction of the tool main body and a blade tip of each of the tool blades is oriented inward in a radial direction of the tool main body. Since the gear cutting tool for skiving is an internal gear type tool, the meshing length at the time of external gear machining can be made (approximately) the same as that at the time of internal gear machining using an external gear type tool. Thus, the degree of wear of the tool blades of the internal gear type tool at the time of external gear machining is lower than the degree of wear of tool blades of an external gear type tool at the time of external gear machining. Thus, the accuracy and the tool life of external gear machining using the internal gear type tool are higher or longer than the accuracy and the tool life of external gear machining using an external gear type tool. As a result, the frequency of replacement of tool blades can be lowered and cost reduction can be made. Since the gear cutting tool is of a tool blades replacement type, reduction can be made from a tool replacement cost that is required by a gear cutting tool made of a solid material to a cost of replacement of only tool blades.

According to another aspect of the present invention, a gear machining apparatus configured to generate a gear tooth to a workpiece includes a rough working tool having a ring-shaped tool main body, and a plurality of tool blades which are replaceable and attached to the tool main body, such that the tool blades are arranged in a circumferential direction of the tool main body and a blade tip of each of the tool blades is oriented inward in a radial direction of the tool main body, a finish working tool having a ring-shaped tool main body, and a plurality of tool blades which are provided to the tool main body, such that the tool blades are arranged in the circumferential direction of the tool main body and the blade tip of each of the tool blades is oriented inward in the radial direction of the tool main body, a tool spindle which rotatably supports each of the rough working tool and the finish working tool, a workpiece spindle which rotatably supports the workpiece and is relatively movable to the tool spindle, a tool magazine which is capable of housing the rough working tool and the finish working tool, a tool replacing unit which is configured to replace the rough working tool and the finish working tool with respect to the tool spindle, a rough machining control unit which is configured to control to perform a rough machining on the workpiece, such that the rough working tool is rotated on a center line in an axial direction of the rough working tool, the workpiece is rotated on a center line in an axial direction of the workpiece, and the rough working tool is relatively moved to the workpiece along the center line in the axial direction of the workpiece, and a finish machining control unit which is configured to control to perform a finish machining on the workpiece, such that the finish working tool is rotated on a center line in an axial direction of the finish working tool, the workpiece is rotated on the center line in the axial direction of the workpiece, and the finish working tool is relatively moved to the workpiece along the center line in the axial direction of the workpiece.

According to another aspect of the present invention, a gear machining method of generating a gear tooth to a workpiece includes performing a rough machining on the workpiece, by rotating a rough working tool on a center line in an axial direction of the rough working tool, rotating the workpiece on a center line in an axial direction of the workpiece, and relatively moving the rough working tool to the workpiece along the center line in the axial direction of the workpiece, the rough working tool having a ring-shaped tool main body and a plurality of the tool blades which are replaceable and attached to the tool main body, such that the tool blades are arranged in the circumferential direction of the tool main body and a blade tip of each of the tool blades is oriented inward in the axial direction of the tool main body, and performing a finish machining on the workpiece such that the gear tooth is generated, by rotating the finish working tool on a center line in an axial direction of the finish working tool, rotating the workpiece on the center line in the axial direction of the workpiece, and relatively moving the finish working tool to the workpiece along the center line in the axial direction of the workpiece, after replacing the rough working tool with a finish working tool, the finish working tool having a ring-shaped tool main body and a plurality of tool blades that are provided to the tool main body, such that the tool blades are arranged in the circumferential direction of the tool main body and the blade tip of each of tool blades is oriented inward on the radial direction of the tool main body.

According to the gear machining apparatus and gear machining method, since the above gear cutting tool is used, a working cost can be reduced.

### BRIEF DESCRIPTION OF DRAWINGS

FIG. 1A is a view, as viewed along its axial line, of a gear cutting tool according to an embodiment of the present disclosure.

FIG. 1B is a view, as viewed from a direction IB, of the gear cutting tool shown in

FIG. 1A.

FIG. 2A is a perspective view of a first rough working tool blade of a first rough working tool of the gear cutting tool.

FIG. 2B is a view, as viewed from a direction IIB, of the first rough working tool blade shown in FIG. 2A.

FIG. 2C is a view, as viewed from a direction IIC, of the first rough working tool blade shown in FIG. 2A.

FIG. 3A is a perspective view of a second rough working tool blade of a second rough working tool of the gear cutting tool.

FIG. 3B is a view, as viewed from a direction IIB, of the second rough working tool blade shown in FIG. 3A.

FIG. 3C is a view, as viewed from a direction IIIC, of the second rough working tool blade shown in FIG. 3A.

FIG. 4A is a perspective view of a first finish working tool blade of a first finish working tool of the gear cutting tool.

FIG. 4B is a view, as viewed from a direction IVB, of the first finish working tool blade shown in FIG. 4A.

FIG. 4C is a view, as viewed from a direction IVC, of the first finish working tool blade shown in FIG. 4A.

FIG. 5 is a perspective view of a second finish working tool as the gear cutting tool.

FIG. 6 shows a rough configuration of a gear machining apparatus according to the embodiment of the present disclosure.

FIG. 7 is a flowchart for description of a gear machining method according to the embodiment of the present disclosure.

FIG. 8A is a view, as viewed from a radial direction of a gear cutting tool, of an arrangement state before a crossing angle is formed that is necessary when a workpiece is machined with the gear cutting tool.

FIG. 8B is a view, as viewed along the axial-line direction of the gear cutting tool, of the arrangement state of FIG. 8A.

FIG. 9A is a view, as viewed from the radial direction of the gear cutting tool, of an arrangement state after the crossing angle is formed that is necessary when the workpiece is machined with the gear cutting tool.

FIG. 9B is a view, as viewed along the axial-line direction of the workpiece, of the arrangement state of FIG. 9A.

FIG. 10A is a view, as viewed from the radial direction of the gear cutting tool, of an arrangement state after an offset angle is formed that is necessary when the workpiece is machined with the gear cutting tool in a case that the gear cutting tool does not have a clearance angle.

FIG. 10B is a view, as viewed along the axial-line direction of the workpiece, of the arrangement state of FIG. 10A.

### DESCRIPTION OF EMBODIMENTS

### (1. Shape of Gear Cutting Tool)

A gear cutting tool according to an embodiment of the present disclosure is a tool blades replacement type, internal gear type tool for producing a gear such as a spur gear or a helical gear by machining a workpiece with skiving. As described above in the related art, conventional replacement type tool blades for skiving are specially manufactured, dedicated inserts rather than common, general-purpose inserts. Where, for example, the finished shape of the tooth surface of each tooth of a gear to be produced is an involute shape, the shape of the blade surface of the dedicated inserts needs to be an involute shape, too, and hence the dedicated inserts are very expensive.

On the other hand, general-purpose inserts are replacement-type lathe-cutting tool blades (lathe-cutting inserts, tips, or throw away inserts) that are used in a cutting tool for lathe-cutting a workpiece. Whereas general-purpose inserts have a triangular blade surface shape and are inexpensive, they cannot produce an involute-shaped tooth shape. Thus, in skiving using the gear-cutting tool according to the embodiment, rough machining for gear teeth formation is performed using general-purpose inserts and a final, involute-shaped tooth shape is formed thereafter by performing finish machining for gear teeth formation using dedicated inserts. This procedure makes it possible to decrease the frequency of working using the expensive, dedicated inserts and thereby lower the working cost.

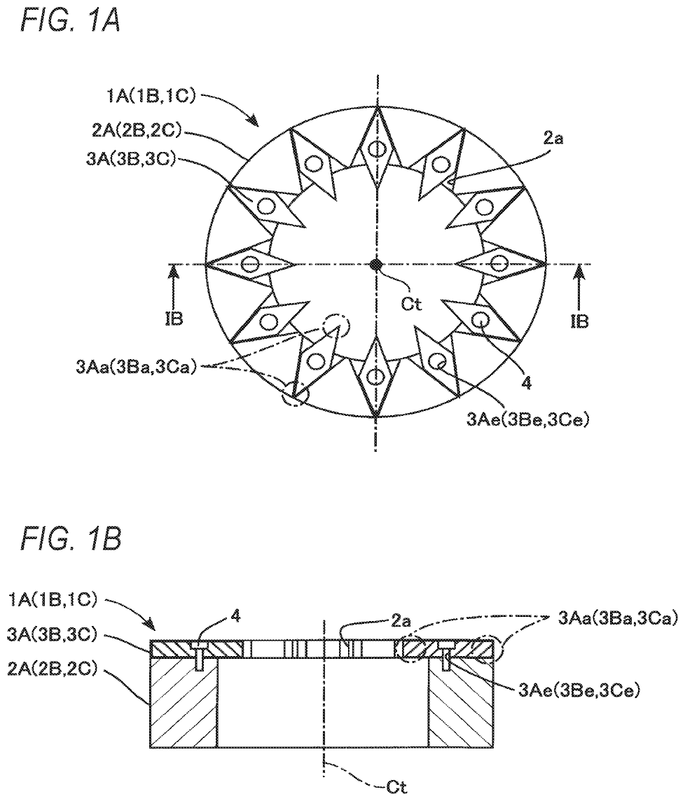

The shape of the gear cutting tool according to the embodiment will be hereinafter described with reference to the drawings. As described later in detail, the gear cutting tool according to the embodiment includes three kinds of cutting tools having the same basic shape (i.e., first rough working tool, second rough working tool, and first finish working tool). Thus, symbols “A,” “B,” and “C” used in FIGS. 1A and 1B correspond to a first rough working tool 1A, a second rough working tool 1B, and a first finish working tool 1C, respectively.

As shown in FIGS. 1A and 1B, the gear cutting tool 1A (1B, 1C) is equipped with a ring-shaped tool main body 2A (2B, 2C) and plural (in this example, 12) replaceable tool blades 3A (3B, 3C) that are attached to the tool main body 2A (2B, 2C) in such a manner that they are arranged in the circumferential direction and one-end-side blade tips 3Aa (3Ba, 3Ca) are directed to the inside. One end surface of the tool main body 2A (2B, 2C) of the gear cutting tool 1A (1B, 1C) is formed with triangular-prism-shaped grooves 2a which are fitted with quadrilateral-prism-shaped (rhombic-prism-shaped) tool blades 3A (3B, 3C) at intervals of the same angle (in this example, 30°).

Each groove 2a is formed so that when the other-end-side blade tip 3Aa (3Ba, 3Ca) of a tool blade 3A (3B, 3C) is fitted into it to establish a close contact, its one-end-side blade tip 3Aa (3Ba, 3Ca) projects beyond the inner circumferential surface of the tool main body 2A (2B, 2C) and the tool blade 3A (3B, 3C) is thereby positioned with high accuracy. The tool blade 3A (3B, 3C) that is fitted in the groove 2a is fastened and fixed by a bolt 4 that is inserted into a bolt hole 3Ae (3Be, 3Ce).

The first rough working tool 1A is equipped with a first rough working tool main body 2A and first rough working tool blades 3A. The second rough working tool 1B is equipped with a second rough working tool main body 2B and second rough working tool blades 3B. The first finish working tool 1C is equipped with a first finish working tool main body 2C and first finish working tool blades 3C. The first rough working tool blades 3A and the second rough working tool blades 3B are tool blades for rough working and are general-purpose inserts. The first finish working tool blades 3C are tool blades for finish machining and are dedicated inserts.

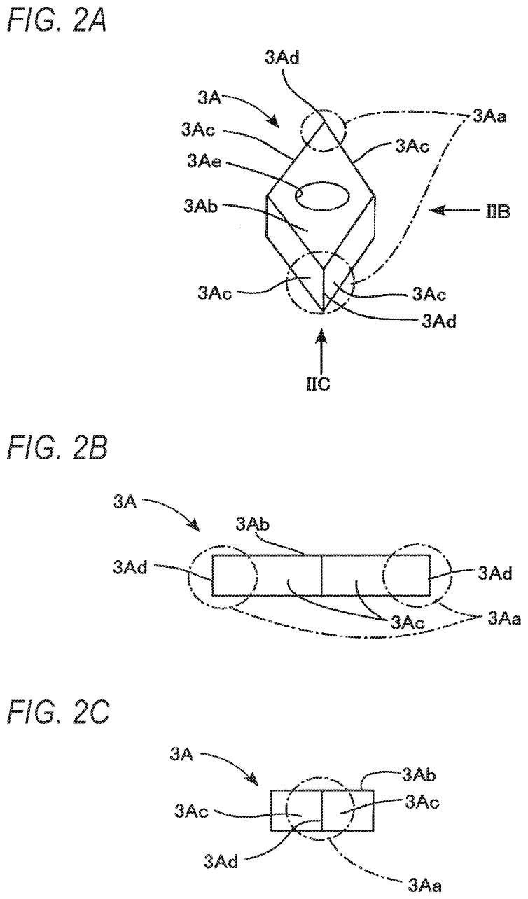

Each first rough working tool blade 3A has a shape that is not based on the shape of the tooth surface of each tooth of a gear to be produced in a workpiece and does not have clearance angle. That is, where the finished shape of the tooth surface of each tooth of a gear to be produced is an involute shape, the “shape that is not based on the shape of the tooth surface of each tooth of a gear” is a shape that cannot produce an involute shape by skiving. More specifically, as shown in FIGS. 2A-2C, each first rough working tool blade 3A is shaped like a quadrilateral prism (rhombic prism) and its two end portions having an acute angle (e.g., 30°) serve as blade tips 3Aa. Each blade tip 3Aa does not have a front clearance angle or side clearance angles.

That is, a ridge line 3Ad between two clearance surfaces 3Ac of each blade tip 3Aa is perpendicular to a top rake surface 3Ab of the blade tip 3Aa (i.e., the angle (front clearance angle) formed by the ridge line 3Ad and the plane perpendicular to the rake surface 3Ab and passing through its apex is 0°) and the clearance surfaces 3Ac on both sides of the rake surface 3Ab form 90° with the rake surface 3Ab (i.e., the angle (side clearance angles) formed by each clearance surface 3Ac and the plane perpendicular to the rake surface 3Ab and including the boundary edge is 0°). A bolt hole 3Ae to be used for attaching the first rough working tool blade 3A to the first rough working tool main body 2A penetrates through the first rough working tool main blade 3A so as to have an opening at the center of the rake surface 3Ab.

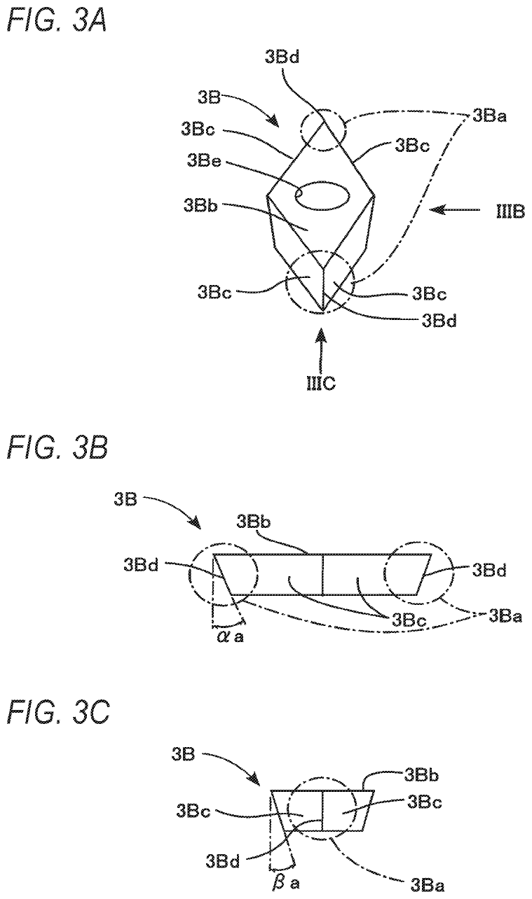

Each second rough working tool blade 3B has a shape that is not based on the shape of the tooth surface of each tooth of the gear to be produced in the workpiece and has clearance angle. More specifically, as shown in FIGS. 3A-3C, each second rough working tool blade 3B is shaped like a quadrilateral prism (rhombic prism) and its two end portions (acute angle portions) having an acute angle (e.g., 30°) serve as blade tips 3Ba. Each blade tip 3Ba has a front clearance angle or side clearance angles.

That is, the angle (front clearance angle) formed by a ridge line 3Bd between two clearance surfaces 3Bc of each blade tip 3Ba and the plane perpendicular to the top rake surface 3Bb of the blade tip 3Ba and passing through its apex is αa° and the angle (side clearance angles) formed by each clearance surface 3Bc and the plane perpendicular to the rake surface 3Bb and including the boundary edge is βa°. A bolt hole 3Be to be used for attaching the second rough working tool blade 3B to the second rough working tool main body 2B penetrates through the second rough working tool main blade 3B so as to have an opening at the center of the rake surface 3Bb.

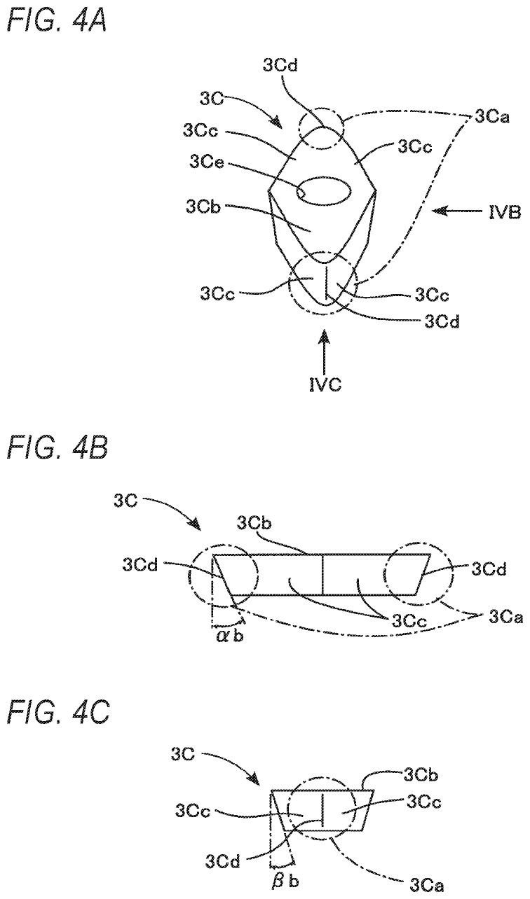

Each first finish working tool blade 3C has a shape that is based on the shape of the tooth surface of each tooth of the gear to be produced in the workpiece and has clearance angle. That is, where the finished shape of the tooth surface of each tooth of the gear to be produced is an involute shape, the “shape that is based on the shape of the tooth surface of each tooth of the gear” is a shape that can produce an involute shape by skiving. More specifically, if the shape of the tooth surface of each tooth of the gear to be produced in the workpiece is, for example, an involute shape, as shown in FIGS. 4A-4C each first finish working tool blade 3C is formed into a similar involute shape and its two end portions having an acute angle serve as blade tips 3Ca. Each first finish working tool blade 3C is the same as each second rough working tool blade 3B in that a front clearance angle (αb°) and side clearance angles (βb°) are formed and that a bolt hole 3Ce to be used for attaching the first finish working tool blade 3C to the first finish working tool main body 2C penetrates through the first finish working tool blade 3C so as to have an opening at the center of a rake surface 3Cb of the first finish working tool blade 3C.

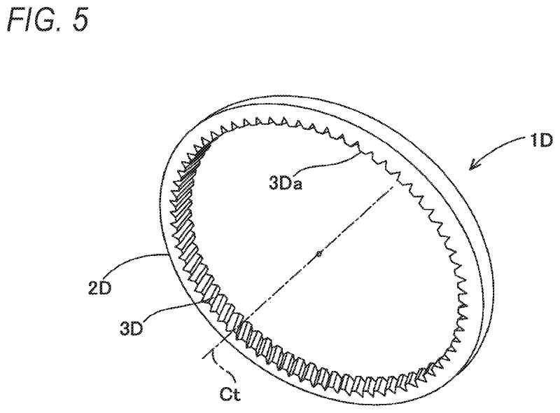

An internal gear type second finish working tool 1D for finish machining shown in FIG. 5 which is made of a solid material can be used as another gear cutting tool in addition to the tool blades replacement type, internal gear type tools described above (first rough working tool 1A, second rough working tool 1B, and first finish working tool 1C). The second finish working tool 1D has plural second finish working tool blades 3D that are unitized with a ring-shaped second finish working tool main body 2D in such a manner that their blade tips 3Da are located on the side of the inner circumference of the second finish working tool main body 2D and directed to the inside. Like each first finish working tool blade 3C shown in FIGS. 3A-3C, each second finish working tool blade 3D has a shape that is based on the shape of the tooth surface of each tooth of the gear to be produced in the workpiece and has clearance angles.

As described above, since the first rough working tool 1A, the second rough working tool 1B, the first finish working tool 1C, and the second finish working tool 1D are internal gear type tools, the meshing length at the time of external gear machining can be made (approximately) the same as that at the time of internal gear machining using an external gear type tool. Thus, the degree of wear of the tool blades of the internal gear type tools (first rough working tool 1A, second rough working tool 1B, first finish working tool 1C, and second finish working tool 1D) at the time of external gear machining is lower than the degree of wear of tool blades of an external gear type tool at the time of external gear machining. Thus, the accuracy and the tool life of external gear machining using the internal gear type tools (first rough working tool 1A, second rough working tool 1B, first finish working tool 1C, and second finish working tool 1D) are higher or longer than the accuracy and the tool life of external gear machining using an external gear type tool. As a result, the frequency of replacement of tool blades can be lowered and cost reduction can be made.

Since the first rough working tool 1A, the second rough working tool 1B, and the first finish working tool 1C are tool blades replacement type working tools, reduction can be made from a tool replacement cost that is required by a gear cutting tool made of solid high speed tool steel to a cost of replacement of only tool blades. Since the first rough working tool 1A and the second rough working tool 1B employ general-purpose tool blades (i.e., first rough working tool blades 3A and second rough working tool blades 3B) which are lower in cost than the tool blades (first finishing tool blades 3C) of the first finish working tool 1C, the working cost can be lowered accordingly.

Each first rough working tool blade 3A assumes a quadrilateral prism shape (rhombic prism shape). The two acute-angled end portions serve as the blade tips 3Aa and each blade tip 3Aa is formed by the two clearance surfaces 3Ac. Thus, in each first rough working tool blade 3A, cutting blades formed on the two respective sides of each of the two blade tips 3Aa (four cutting blades in total) can be used as working execution portions. In other words, the lathe-cutting insert has an angled portion which is cutting part of the lathe-cutting insert. As a result, the working cost can be made lower through reduction of the frequency of replacement of tool blades than in a working tool blade having only two working execution portions like the conventional replacement type tool blade for skiving described in the related art. The same is true of the second rough working tool 1B and the first finish working tool 1C.

Although each first rough working tool blade 3A assumes a quadrilateral prism shape (rhombic prism shape) and has four working execution portions, each first rough working tool blade may be shaped like a prism that assumes a regular triangle in cross section (it has six working execution portions in total). This working tool can lower the working cost through reduction of the frequency of replacement of tool blades. The same is true of the second rough working tool 1B and first finish working tool 1C.

Since the first rough working tool 1A and the second rough working tool 1B are used only for rough machining that need not be high accuracy working, the accuracy of attachment at the time of replacement of the first rough working tool blades 3A or the second rough working tool blades 3B need not be high and hence work of replacing them can be performed in a shorter time. On the other hand, since the first finish working tool 1C and the second finish working tool 1D are used only for finish machining that should be high accuracy working, the working load can be lowered by decreasing the number of working paths of production of gear teeth. As a result, the manufacturing cost can be lowered through reduction of the degrees of wear of the first finish working tool blades 3C and the second finish working tool blades 3D and resulting reduction of the frequency of replacement of tools.

### (2. Configuration of Gear Machining Apparatus 10)

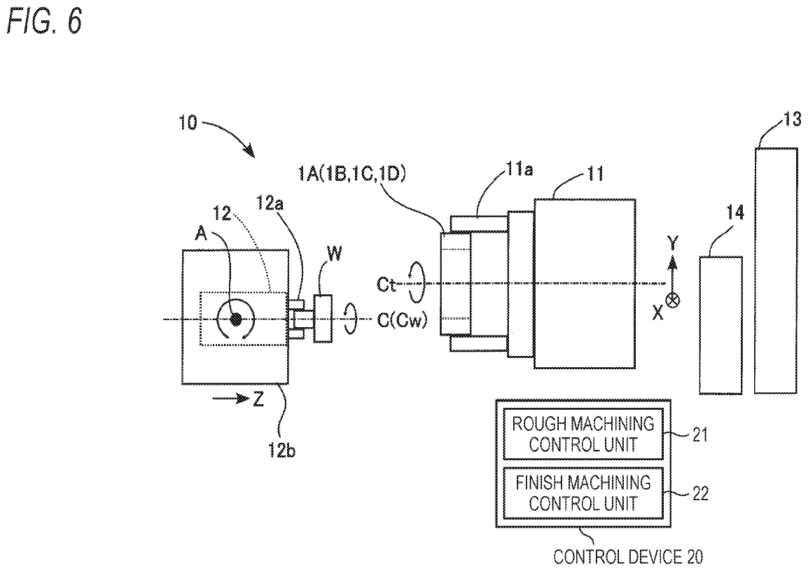

The configuration of a gear machining apparatus 10 according to the embodiment of the present disclosure will be described with reference to FIG. 6. As shown in FIG. 6, for example, the gear machining apparatus 10 is a 5-axis machining center that enables movement in each of three orthogonal axes (X axis, Y axis, and Z axis), rotation about a C axis (axial line Cw of a workpiece W), and a swing about an A axis. The gear machining apparatus 10 is equipped with the first rough working tool 1A or the second rough working tool 1B and the first finish working tool 1C or the second finish working tool 1D, a tool spindle 11 capable of rotating while supporting the first rough working tool 1A, the second rough working tool 1B, the first finish working tool 1C, or the second finish working tool 1D, a workpiece spindle 12 capable of rotating while supporting the workpiece W and capable of moving relative to the tool spindle 11, a tool magazine 13 capable of housing the first rough working tool 1A or the second rough working tool 1B and the first finish working tool 1C or the second finish working tool 1D, a tool switching device 14 for switching the tool attached to the tool spindle 11 between the first rough working tool 1A or the second rough working tool 1B and the first finish working tool 1C or the second finish working tool 1D, a control device 20 for controlling an operation of producing gear teeth, and others.

The tool spindle 11 which is disposed on a bed (not shown) supports, via a chuck 11a, the first rough working tool 1A, the second rough working tool 1B, the first finish working tool 1C, or the second finish working tool 1D in such a manner that it can rotate about the axial line Ct of the gear cutting tool 1. Furthermore, the tool spindle 11 can move in the X-axis direction and the Y-axis direction over the bed. Thus, the first rough working tool 1A, the second rough working tool 1B, the first finish working tool 1C, or the second finish working tool 1D can rotate about its axial line Ct and move in the X-axis direction and the Y-axis direction relative to the bed.

The workpiece spindle 12 which is disposed over the bed supports, via a chuck 12a, the workpiece W in such a manner that the workpiece W can rotate about the C axis, that is, the axial line Cw of the workpiece W. The workpiece spindle 12 is supported by a tilt table 12b (which is disposed on the bed) so as to be swingable (tiltable) about the A axis. The workpiece spindle 12 which is supported by the tilt table 12b can move in the Z-axis direction over the bed. As a result, the workpiece W can rotate about its axial line Cw, swing about the A axis relative to the bed, and move in the Z-axis direction.

Although the statement was made above to the effect that the tool magazine 13 houses the first rough working tool 1A or the second rough working tool 1B as a rough working tool and houses the first finish working tool 1C or the second finish working tool 1D as a finish working tool, the tool magazine 13 may be such as to house all of the first rough working tool 1A, the second rough working tool 1B, the first finish working tool 1C, and the second finish working tool 1D

The control device 20 is equipped with a rough machining control unit 21 for controlling rough machining on the workpiece W by the first rough working tool 1A or the second rough working tool 1B and a finish machining control unit 22 for controlling finish machining on the workpiece W by the first finish working tool 1C or the second finish working tool 1D. The control device 20 moves the first rough working tool 1A, the second rough working tool 1B, the first finish working tool 1C, or the second finish working tool 1D being supported by the tool spindle 11 in each of the X-axis direction and the Y-axis direction by drive-controlling screw mechanisms and drive motors (not shown) for moving the tool spindle 11 and moves the workpiece W being supported by the workpiece spindle 12 in the Z-axis direction by drive-controlling a screw mechanism and a drive motor (not shown) for moving the workpiece spindle 12.

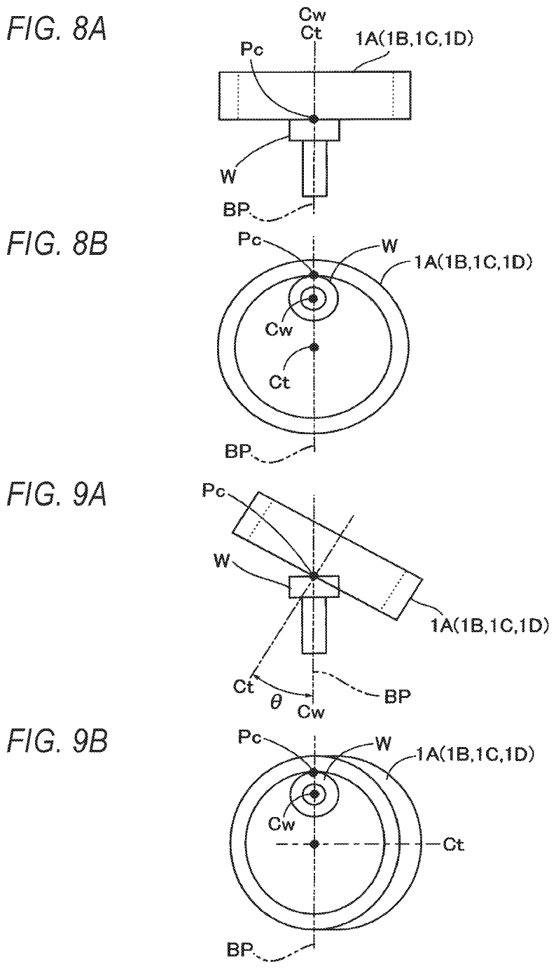

As shown in FIGS. 8A and 8B, the control device 20 sets the axial line Ct of the first rough working tool 1A, the second rough working tool 1B, the first finish working tool 1C, or the second finish working tool 1D being supported by the tool spindle 11 and the axial line Cw of the workpiece W being supported by the workpiece spindle 12 parallel with each other (reference state). The plane that includes the axial lines Ct and Cw is defined as a reference plane BP.

Furthermore, the control device 20 swings the workpiece W being supported by the tilt table 12b about the A axis by drive-controlling a drive motor for the tilt table 12b. As shown in FIGS. 9A and 9B, the control device 20 inclines the axial line Ct of the first rough working tool 1A, the second rough working tool 1B, the first finish working tool 1C, or the second finish working tool 1D being supported by the tool spindle 11 from the reference plane BP toward the direction perpendicular to it by a crossing angle θ. The crossing angle θ is adjusted on the basis of a twist angle of teeth of a gear to be produced in the workpiece W and a twist angle of the first rough working tool 1A, the second rough working tool 1B, the first finish working tool 1C, or the second finish working tool 1D.

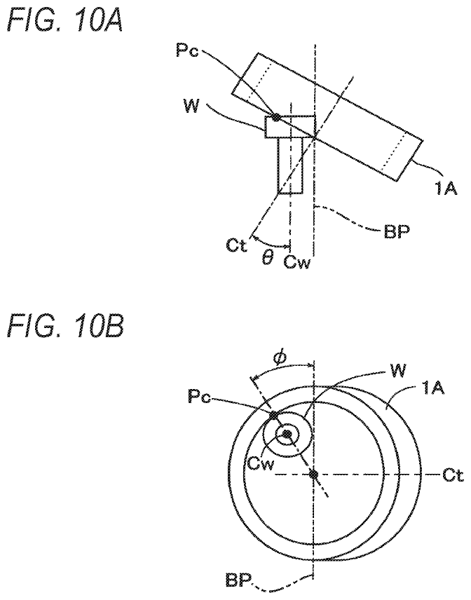

When the first rough working tool 1A is supported by the tool spindle 11, as shown in FIGS. 10A and 10B the control device 20 sets a machining point Pc of the first rough working tool 1A and the workpiece W to a position (offset position) that is deviated from a reference position in the reference plane BP by an offset angle φ in the circumferential direction of the workpiece W. The control for positioning the first rough working tool 1A so that the machining point Pc is located at the offset position is a common control that is performed to secure a clearance angle in the case where no clearance angle are formed as in the first rough working tool blades 3A of the first rough working tool 1A. Even with the second rough working tool 1B, the first finish working tool 1C, or the second finish working tool 1D having the clearance angles, the second rough working tool 1B, the first finish working tool 1C, or the second finish working tool 1D is positioned so that a machining point Pc is located at an offset position having a prescribed offset angle if a further prescribed clearance angle is necessary.

Still further, the control device 20 rotates the first rough working tool 1A, the second rough working tool 1B, the first finish working tool 1C, or the second finish working tool 1D being supported by the tool spindle 11 about the axial line Ct by drive-controlling a drive motor for rotating the tool spindle 11. And the control device 20 rotates the workpiece W being supported by the workpiece spindle 12 about the axial line Cw by driving a drive motor for rotating the workpiece spindle 12. Furthermore, the control unit 20 controls rough machining or finish machining on the workpiece W by moving the first rough working tool 1A, the second rough working tool 1B, the first finish working tool 1C, or the second finish working tool 1D being supported by the tool spindle 11 in the axial line Cw direction of the workpiece W being supported by the workpiece spindle 12 by drive-controlling the screw mechanisms and the drive motors for moving the tool spindle 11 and the workpiece spindle 12.

### (3. Operation of Control Device 20 of Gear Machining Apparatus 10)

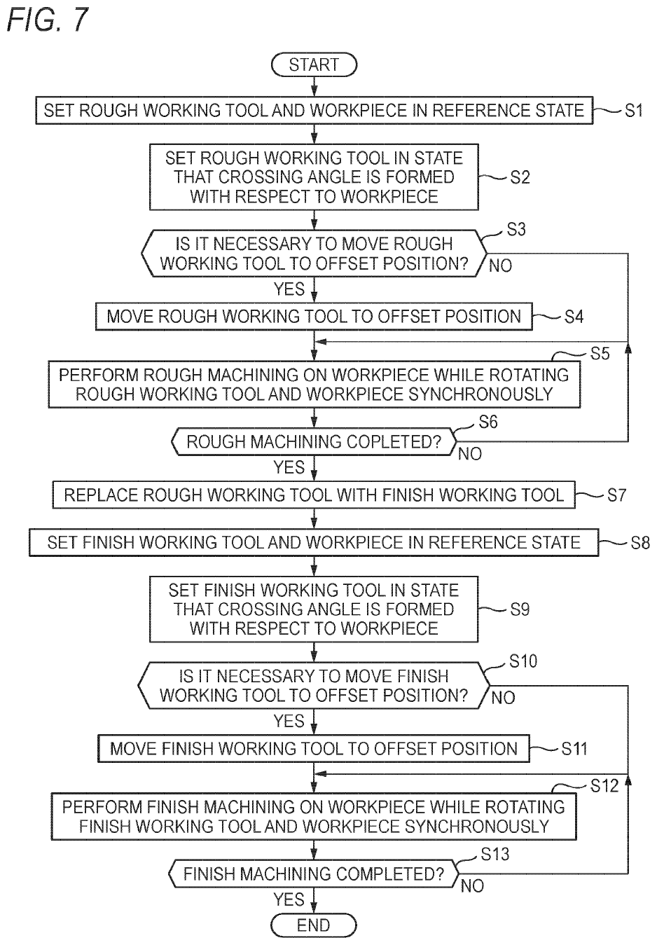

Next, how the control device 20 of the gear machining apparatus 10 operates (gear machining method) will be described with reference to FIG. 7. It is assumed that the first rough working tool 1A is attached to the tool spindle 11 and the first finish working tool 1C is housed in the tool magazine 13. It is also assumed that a workpiece W that is composed of a large-diameter cylindrical member and a small-diameter cylindrical member that is concentric with and is unitized with the large-diameter cylindrical member is supported by the workpiece spindle 12 and that the gear machining apparatus 10 is to produce teeth of a gear in the outer circumferential surface of the large-diameter cylindrical member of the workpiece W by means of the first rough working tool 1A and the first finish working tool 1C. The control device 20 executes the process shown in FIG. 7 also in the case of using the second rough working tool 1B instead of the first rough working tool 1A or using the second finish working tool 1D instead of the first finish working tool 1C.

As shown in FIGS. 8A and 8B, at step S1 of a rough machining process, the control device 20 sets the first rough working tool 1A and the workpiece W in a reference state. Then, as shown in FIGS. 9A and 9B, at step S2, the control device 20 sets the first rough working tool 1A in a state that it forms a crossing angle θ with the workpiece W.

At step S3, the control device 20 judges whether it is necessary to move a machining point Pc of the first rough working tool 1A and the work W to an offset position. If it is not necessary to move the machining point Pc to an offset position, the control device 20 goes to step S5. In this example, each first rough working tool blade 3A of the first rough working tool 1A has no clearance angle and hence it is necessary to move the machining point Pc to an offset position. Thus, as shown in FIGS. 10A and 10B, at step S4, the control unit 20 moves the machining point Pc of the first rough working tool 1A and the workpiece W to the offset position while maintaining the crossing angle θ.

At step S5, the control device 20 performs rough machining on the outer circumferential surface of the large-diameter cylindrical member of the workpiece W by feeding (moving) the first rough working tool 1A in the axial line Cw direction of the workpiece W while rotating the first rough working tool 1A and the workpiece W synchronously. At step S6, the control device 20 judges whether the rough machining on the outer circumferential surface of the large-diameter cylindrical member of the workpiece W has been completed. If the rough machining on the outer circumferential surface of the large-diameter cylindrical member of the workpiece W has not been completed yet, the control device 20 returns to step S5.

On the other hand, if the rough machining on the outer circumferential surface of the large-diameter cylindrical member of the workpiece W has been completed, at step S7 of a finish machining process, the control device 20 replaces the first rough working tool 1A with the first finish working tool 1C using the tool switching device 14. Then, as shown in FIGS. 8A and 8B, at step S8, the control device 20 sets the first finish working tool 1C and the workpiece W in a reference state. Then, as shown in FIGS. 9A and 9B, at step S9, the control device 20 sets the first finish working tool 1C in a state that it forms a crossing angle θ with the workpiece W.

At step S10, the control device 20 judges whether it is necessary to move a machining point Pc of the first finish working tool 1C and the workpiece W to an offset position. If it is necessary to move the machining point Pc to an offset position, the control device 20 moves the machining point Pc to the offset position at step S11. However, in this example, since each first finish working tool blade 3C of the first finish working tool 1C has clearance angles and hence it is not necessary to move the machining point Pc to an offset position. Thus, the control unit 20 goes to step S12.

At step S12, the control device 20 performs finish machining on the teeth that are formed in the outer circumferential surface of the large-diameter cylindrical member of the workpiece W by feeding (moving) the first finish working tool 1C in the axial line Cw direction of the workpiece W while rotating the first finish working tool 1C and the workpiece W synchronously. At step S13, the control device 20 judges whether the finish machining on the teeth that are formed in the outer circumferential surface of the large-diameter cylindrical member of the workpiece W has been completed. If the finish machining on the teeth that are formed in the outer circumferential surface of the large-diameter cylindrical member of the workpiece W has not been completed yet, the control device 20 returns to step S12. On the other hand, if the finish machining on the teeth that are formed in the outer circumferential surface of the large-diameter cylindrical member of the workpiece W has been completed, the execution of the entire process is finished.

### (4. Others)

Although the above-described embodiment is directed to the case that the first rough working tool 1A, the second rough working tool 1B, the first finish working tool IC, and the second finish working tool 1D are tools for producing teeth of a gear, they can also be used as tools for chamfering tips of teeth or gear teeth of a spline mechanism or a synchromesh mechanism or tools for performing working on, for example, a missing tooth portion of a gear.

In the above embodiment, the gear machining apparatus 10 is configured in such a manner that the tool spindle 11 is movable in the X-axis direction and the Y-axis direction with respect to the workpiece spindle 12 and the workpiece spindle 12 is movable in the Z-axis direction with respect to the tool spindle 11. However, the gear machining apparatus 10 may be modified so that the tool spindle 11 and the workpiece spindle 12 can move relative to each other. Although in the embodiment the gear machining apparatus 10 is configured in such a manner that the workpiece spindle 12 is swingable (tiltable) about the A axis with respect to the tool spindle 11, the gear machining apparatus 10 may be modified so that the tool spindle 11 is swingable (tiltable) with respect to the workpiece spindle 12.

What is claimed is:

1. A gear cutting tool configured to machine a workpiece with a skiving so as to generate a gear tooth, the gear cutting tool comprising:
a ring-shaped tool main body; and
a plurality of tool blades which are replaceable and attached to the tool main body, such that the tool blades are arranged in a circumferential direction of the tool main body and a blade tip of each of the tool blades is oriented inward in a radial direction of the tool main body.

2. The gear cutting tool according to claim 1,
wherein the tool blades are configured to be applied in a rough machining, and each of the tool blades has a shape that is not based on a finished shape of a tooth surface of the gear tooth, each of the tool blades not having a clearance angle; and
wherein the gear cutting tool has a crossing angle with respect to the workpiece, and is configured to be applied in a gear machining in which a machining point between the gear cutting tool and the workpiece is located at a position that is offset in a circumferential direction of the workpiece.

3. The gear cutting tool according to claim 1,
wherein the tool blades are configured to be applied in a rough machining, and each of the tool blades has a shape that is not based on a finished shape of a tooth surface of the gear tooth, each of the tool blades having a clearance angle; and
wherein the gear cutting tool has a crossing angle with respect to the workpiece, and is configured to be applied in a gear machining in which a machining point between the gear cutting tool and the workpiece is located at a reference position that is not offset in a circumferential direction of the workpiece or a position that is offset in the circumferential direction of the workpiece.

4. The gear cutting tool according to claim 1,
wherein the tool blades are configured to be applied in a finish machining, and each of the tool blades has a shape that is based on a finished shape of a tooth surface of the gear tooth, each of the tool blades having a clearance angle; and
wherein the gear cutting tool has a crossing angle with respect to the workpiece, and is configured to be applied in a gear machining in which a machining point between the gear cutting tool and the workpiece is located at a reference position that is not offset in a circumferential direction of the workpiece or a position that is offset in the circumferential direction of the workpiece.

5. The gear cutting tool according to claim 2,
wherein the finished shape of the tooth surface of the gear tooth includes an involute shape; and
wherein the shape which is not based on the finished shape of the tooth surface of the gear tooth is a shape that cannot generate the involute shape with the skiving.

6. The gear cutting tool according to claim 4,
wherein the finished shape of the tooth surface of the gear tooth includes an involute shape; and
wherein the shape which is based on the finished shape of the tooth surface of the gear tooth is a shape that can generate the involute shape with the skiving.

7. The gear cutting tool according to claim 2,
wherein each of the tool blades includes a lathe-cutting insert, and
wherein the lathe-cutting insert is configured to be applied in the rough machining.

8. The gear cutting tool according to claim 7,
wherein the lathe-cutting insert is formed in a rhombus or a equilateral triangle to have an angled portion, and
wherein the angled portion of the lathe-cutting insert is configured such that the angled portion is a cutting part of the lathe-cutting insert.

9. A gear machining apparatus configured to generate a gear tooth to a workpiece, the gear machining apparatus comprising:
a rough working tool having a ring-shaped tool main body, and a plurality of tool blades which are replaceable and attached to the tool main body, such that the tool blades are arranged in a circumferential direction of the tool main body and a blade tip of each of the tool blades is oriented inward in a radial direction of the tool main body;
a finish working tool having a ring-shaped tool main body, and a plurality of tool blades which are provided to the tool main body, such that the tool blades are arranged in the circumferential direction of the tool main body and the blade tip of each of the tool blades is oriented inward in the radial direction of the tool main body;
a tool spindle which rotatably supports each of the rough working tool and the finish working tool;
a workpiece spindle which rotatably supports the workpiece and is relatively movable to the tool spindle;
a tool magazine which is capable of housing the rough working tool and the finish working tool;
a tool replacing unit which is configured to replace the rough working tool and the finish working tool with respect to the tool spindle;
a rough machining control unit which is configured to control to perform a rough machining on the workpiece, such that the rough working tool is rotated on a center line in an axial direction of the rough working tool, the workpiece is rotated on a center line in an axial direction of the workpiece, and the rough working tool is relatively moved to the workpiece along the center line in the axial direction of the workpiece; and
a finish machining control unit which is configured to control to perform a finish machining on the workpiece, such that the finish working tool is rotated on a center line in an axial direction of the finish working tool, the workpiece is rotated on the center line in the axial direction of the workpiece, and the finish working tool is relatively moved to the workpiece along the center line in the axial direction of the workpiece.

10. The gear machining apparatus according to claim 9,
wherein each of the tool blades of the rough working tool has a shape that is not based on a finished shape of a tooth surface of the gear tooth, each of the tool blades not having a clearance angle; and
wherein the rough machining control unit is configured to control to perform the rough machining on the workpiece with the rough working tool, such that the rough working tool has a crossing angle with respect to the workpiece, and a machining point between the rough working tool and the workpiece is located at a position that is offset in a circumferential direction of the workpiece.

11. The gear machining gear machining apparatus according to claim 9,
wherein each of the tool blades of the rough working tool has a shape that is not based on a finished shape of a tooth surface of the gear tooth, each of the tool blades having a clearance angle; and
wherein the rough machining control unit is configured to control to perform the rough machining on the workpiece with the rough working tool, such that the rough machining tool has a crossing angle with respect to the workpiece, and a machining point between the rough working tool and the workpiece is located at a reference position that is not offset in a circumferential direction of the workpiece or a position that is offset in the circumferential direction of the workpiece.

12. The gear machining apparatus according to claim 9,
wherein each of the tool blades of the finish working tool is replaceable, each of the tool blades having a shape that is based on a finished shape of a tool surface of the gear tooth, and having a clearance angle; and
wherein the finish machining control unit is configured to control to perform the finish machining on the workpiece with the finish working tool, such that the finish working tool has a crossing angle with respect to the workpiece, and a machining point between the finish working tool and the workpiece is located at a reference position that is not offset in a circumferential direction of the workpiece or a position that is offset in the circumferential direction of the workpiece.

13. The gear machining apparatus according to claim 9,
wherein each of the tool blades of the finish working tool are integrally formed on the tool main body, each of the tool blades having a shape that is based on a finished shape of a tooth surface of the gear tooth, and having a clearance angle; and
wherein the finish machining control unit is configured to control to perform the finish machining on the workpiece with the finish working tool, such that the finish working tool has a crossing angle with respect to the workpiece, and a machining point between the finish working tool and the workpiece is located at a reference position that is not offset in a circumferential direction of the workpiece or a position that is offset in the circumferential direction of the workpiece.

14. A gear machining method of generating a gear tooth to a workpiece, comprising:
performing a rough machining on the workpiece, by rotating a rough working tool on a center line in an axial direction of the rough working tool, rotating the workpiece on a center line in an axial direction of the workpiece, and relatively moving the rough working tool to the workpiece along the center line in the axial direction of the workpiece, the rough working tool having a ring-shaped tool main body and a plurality of the tool blades which are replaceable and attached to the tool main body, such that the tool blades are arranged in the circumferential direction of the tool main body and a blade tip of each of the tool blades is oriented inward in the axial direction of the tool main body; and
performing a finish machining on the workpiece such that the gear tooth is generated, by rotating the finish working tool on a center line in an axial direction of the finish working tool, rotating the workpiece on the center line in the axial direction of the workpiece, and relatively moving the finish working tool to the workpiece along the center line in the axial direction of the workpiece, after replacing the rough working tool with a finish working tool, the finish working tool having a ring-shaped tool main body and a plurality of tool blades that are provided to the tool main body, such that the tool blades are arranged in the circumferential direction of the tool main body and the blade tip of each of tool blades is oriented inward on the radial direction of the tool main body.
